(19) United States
(12) Patent Application Publication
(10) Pub. No.: US 2026/0253513 A1
(43) Pub. Date: Aug. 27, 2026

(54) DYNAMIC ORBITAL DISPLAY SYSTEM

(71) Applicant: ANALOG EXPERIENCES LLC, Reno, NV (US)

(72) Inventor: Ryan Foltz, Reno, NV (US)

(21) Appl. No.: 19/545,732

(22) Filed: Feb. 20, 2026

Related U.S. Application Data
(60) Provisional application No. 63/762,547, filed on Feb. 24, 2025.

(51) Int. Cl. G09B 27/08

(52) U.S. Cl. CPC G09B 27/08

(57) ABSTRACT

An orbital display system includes a body, a primary shaft extending through the body along a primary rotational axis, at least one bearing assembly permitting relative rotation between the body and the primary shaft about the primary rotational axis, a central bearing assembly defining a secondary rotational axis that is non-parallel to the primary rotational axis, an extending member coupled to the central bearing assembly and extending radially outward from the secondary rotational axis, an internal magnet positioned at a distal end of the extending member, an internal guiding cavity that receives and constrains movement of the internal magnet, and an orbiting object positioned externally relative to the body and magnetically coupled to the internal magnet. Rotation of the body about the primary rotational axis causes displacement of the extending member about the secondary rotational axis and corresponding movement of the orbiting object relative to the body.

### CROSS-REFERENCE TO RELATED APPLICATIONS

The present disclosure claims priority to U.S. Provisional Application No. 63,762,547, filed on February 24, 2025, and entitled “DYNAMIC ORBITAL DISPLAY SYSTEM,” which is incorporated herein by reference in its entirety.

### TECHNICAL FIELD

The present disclosure relates to display systems configured to simulate motion of an object relative a body, and more particularly, to a coordinated multi-axis orbital guidance system that may control both position and orientation of an orbiting entity relative to a rotating body.

### BACKGROUND

Traditional display systems intended to simulate orbiting motion or relative movement of objects about a body often rely on rigid external arms that physically connect an orbiting object to a central support. While these traditional display systems may produce circular motion, the orbiting object employed in these display systems is generally constrained to a fixed planar path and/or orientation. Furthermore, conventional display systems lack automatic heading correction, and often implement visible (e.g., external) mechanical supports that detract from a visual experience of a user.

Accordingly, a need exists for an orbital display system that produces smooth, predictable, and visually compelling orbital motion of an external orbiting object without exposed linkages or other similar steering mechanism that detract from a user experience.

### SUMMARY

In an embodiment of the present disclosure, an orbital display system is disclosed. The orbital display system includes a body, a primary shaft extending through the body along a primary rotational axis, at least one bearing assembly permitting relative rotation between the body and the primary shaft about the primary rotational axis, a central bearing assembly defining a secondary rotational axis that is non-parallel to the primary rotational axis, an extending member coupled to the central bearing assembly and extending radially outward from the secondary rotational axis, an internal magnet positioned at a distal end of the extending member, an internal guiding cavity that receives and constrains movement of the internal magnet, and an orbiting object positioned externally relative to the body and magnetically coupled to the internal magnet. Rotation of the body about the primary rotational axis causes displacement of the extending member about the secondary rotational axis and corresponding movement of the orbiting object relative to the body.

In another embodiment of the present disclosure, an orbital display system is disclosed. The orbital display system includes a body including a lower body portion and an upper body portion releasably coupled to the lower body portion, a primary shaft extending through the body along a primary rotational axis, a central bearing assembly positioned at a center of the body, an extending member having a fixed length and coupled to the central bearing assembly, an internal guiding cavity formed within the body and defined at least in part by the lower body portion and the upper body portion, an internal magnet positioned within the internal guiding cavity and coupled to a distal extending member end of the extending member, and an orbiting object magnetically coupled to the internal magnet, such that the orbiting object is external to the body. Rotation of the primary shaft about the primary rotational axis causes displacement of the extending member about the secondary rotational axis and corresponding movement of the orbiting object relative to the body.

In yet another embodiment of the present disclosure, an orbital display system is disclosed. The orbital display system includes a body, a primary shaft defining a primary rotational axis, a central bearing assembly defining a secondary rotational axis, an extending member coupled to the central bearing assembly, an internal magnet coupled to the extending member, a guiding rail configured to constrain movement of the internal magnet, and an adjustment mechanism configured to vary an angular orientation of the guiding rail relative to the primary rotational axis. Varying the angular orientation of the guiding rail modifies a displacement path imposed on the internal magnet during rotation about the primary rotational axis.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an exploded perspective view of an embodiment of an orbital display system, according to one or more embodiments shown and described herein;

FIG. 2 schematically depicts another exploded perspective view of the orbital display system of FIG. 1, according to one or more embodiments shown and described herein;

FIG. 3 schematically depicts a partially assembled perspective view of the orbital display system of FIG. 1, according to one or more embodiments shown and described herein;

FIG. 4 schematically depicts an assembled perspective view of the orbital display system of FIG. 1, according to one or more embodiments shown and described herein;

FIG. 5 schematically depicts an assembled perspective view of the orbital display system of FIG. 1, according to one or more embodiments shown and described herein;

FIG. 6 schematically depicts an assembled perspective view of the orbital display system of FIG. 1, according to one or more embodiments shown and described herein;

FIG. 7 schematically depicts an assembled perspective view of the orbital display system of FIG. 1, according to one or more embodiments shown and described herein;

FIG. 8 schematically depicts a cross-sectional view of the orbital display system of FIG. 4, according to one or more embodiments shown and described herein;

FIG. 9 schematically depicts a cross-sectional view of the orbital display system of FIG. 5, according to one or more embodiments shown and described herein;

FIG. 10 schematically depicts a cross-sectional view of the orbital display system of FIG. 6, according to one or more embodiments shown and described herein;

FIG. 11 schematically depicts a perspective view of another embodiment of an orbital display system including an adjustable rail, according to one or more embodiments shown and described herein;

FIG. 12 schematically depicts a side view of a drive interface of the orbital display system of FIG. 11, according to one or more embodiments shown and described herein;

FIG. 13 schematically depicts a side view of a drive interface of the orbital display system of FIG. 11, according to one or more embodiments shown and described herein; and

FIG. 14 schematically depicts a partial perspective view of the drive interface of the orbital display system of FIG. 11, according to one or more embodiments shown and described herein.

Other features and advantages of the present disclosure will be understood from the following embodiments described in detail herein and with reference to the accompanying drawings, in which like reference numerals represent the same or similar components.

### DETAILED DESCRIPTION

In the embodiments described herein an orbital display system includes a body, a primary shaft extending through the body along a primary rotational axis, at least one bearing assembly permitting relative rotation between the body and the primary shaft about the primary rotational axis, a central bearing assembly defining a secondary rotational axis that is non-parallel to the primary rotational axis, an extending member coupled to the central bearing assembly and extending radially outward from the secondary rotational axis, an internal magnet positioned at a distal end of the extending member, an internal guiding cavity that receives and constrains movement of the internal magnet, and an orbiting object positioned externally relative to the body and magnetically coupled to the internal magnet. Rotation of the body about the primary rotational axis causes displacement of the extending member about the secondary rotational axis and corresponding movement of the orbiting object relative to the body. The disclosed orbital display system produces smooth, predictable, and aesthetically pleasing orbital motion through coordinated body rotation and cavity-imposed guidance without use of exposed linkages.

It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

As described hereinabove, traditional orbital display systems rely on rigid external arms that constrain an orbiting object to a fixed planar path and a fixed orientation. Furthermore, mechanical guidance mechanisms employed by traditional orbital display systems are commonly positioned externally relative a central body of the system, which may prevent automatic heading correction of the orbiting object and detract from the visual realism of the system. To this extent, it should be further appreciated that the mechanical guidance mechanisms implemented by traditional orbital display systems are also unable to provide multi-plane positional translation of the orbiting object in coordination with rotation of a central body of the system.

The disclosed dynamic orbital display system addresses these shortcomings by implementing an internal mechanism that includes a plurality of orthogonal rotation axes, an extending member, a cavity-guided magnet assembly, and a magnetically coupled orbiting object that produces smooth, predictable, and aesthetically pleasing orbital motion through coordinated body rotation and cavity-imposed guidance without use of exposed linkages.

Embodiments of dynamic orbital display systems will now be described in additional detail herein. The following will now describe these orbital display systems in detail with reference to the drawings and where like numbers refer to like structures.

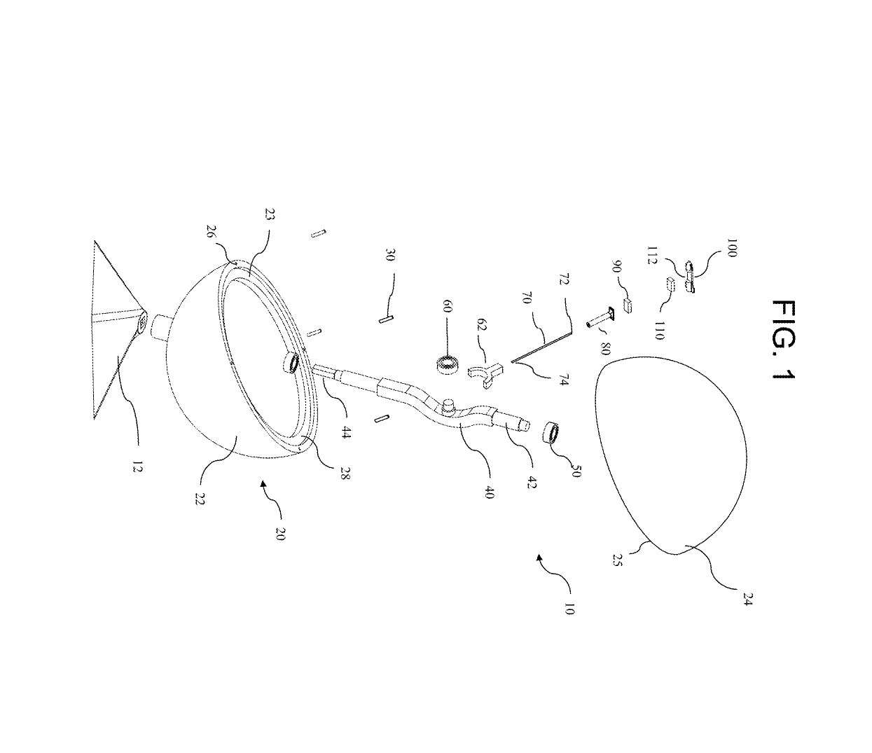

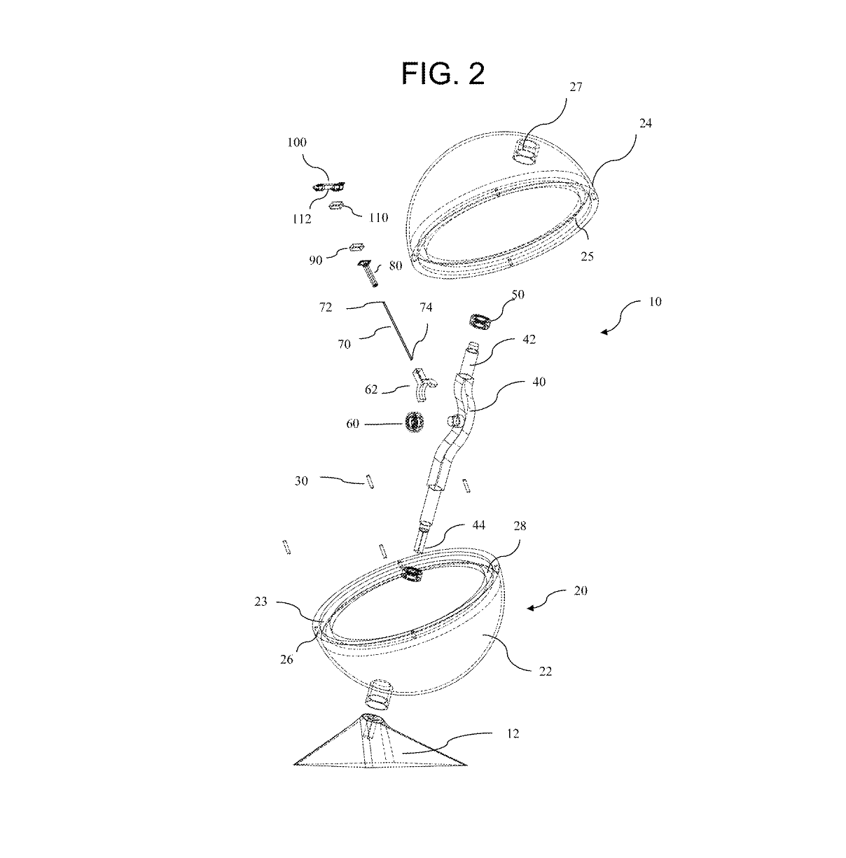

Referring now to FIGS. 1 and 2, an orbital display system 10 depicted. In these embodiments, the orbital display system 10 may include a base 12, a body 20 including a lower body portion 22 and an upper body portion 24, a plurality of alignment members 30 configured for joining the lower body portion 22 and the upper body portion 24, a primary shaft 40, a plurality of bearing assemblies 50 positioned at opposite ends of the primary shaft 40 (e.g., at a first primary shaft end 42 and a second primary shaft end 44 positioned opposite the first primary shaft end 42), a central bearing assembly 60 positioned along the primary shaft 40, a radial extending member 70 extending between a distal extending member end 72 and a proximal extending member end 74, a swivel assembly 80 positioned at the distal extending member end 72 of the radial extending member 70, an internal magnet 90, and an orbiting object 100 configured to magnetically couple with the internal magnet 90.

As further illustrated in FIGS. 1 and 2, the lower body portion 22 and the upper body portion 24 may be generally hemispherical in shape and may be configured to mate along a circumferential seam to form a substantially enclosed spherical body. Although the lower body portion 22 and the upper body portion 24 are depicted as hemispherical portions and the body 20 is depicted as a spherical body, it should be appreciated that the lower body portion 22, the upper body portion 24, and the corresponding body 20 may take any other similar geometric shape (e.g., cylindrical, etc.) without departing from the scope of the present disclosure.

In the embodiments described herein, each of the lower body portion 22 and the upper body portion 24 may include a plurality of alignment openings 26, such as a plurality of apertures, which may be positioned adjacent the circumferential seam. Accordingly, the plurality of alignment members 30 may be inserted into the plurality of alignment openings 26, such that the lower body portion 22 and upper body portion 24 may be releasably and/or fixedly bound to form the body 20. It should be appreciated that the lower body portion 22 and upper body portion 24 may be positioned in fixed angular alignment relative to one another when the plurality of alignment members 30 are inserted into the plurality of alignment openings 26, thereby ensuring proper registration of internal structural features. Furthermore, it should be understood that, although the plurality of alignment openings 26 are depicted as including a plurality of apertures, the plurality of alignment openings may include cylindrical bores, sockets, recesses, or any other similar openings configured to receive corresponding alignment pins or dowels (e.g., alignment members 30) without departing from the scope of the present disclosure.

Referring still to FIGS. 1 and 2, each of the lower body portion 22 and the upper body portion 24 further may include a partially formed internal rail or cavity extending along an interior surface adjacent the circumferential seam. For example, in these embodiments, the lower body portion 22 may define a lower cavity portion 23 and the upper body portion 24 may define an upper cavity portion 25, such that, when the lower body portion 22 and the upper body portion 24 are assembled, the lower cavity portion 23 and the upper cavity portion 25 cooperate to form a continuous enclosed internal guiding cavity 28.

In these embodiments, the internal guiding cavity 28 may be further defined by opposing lateral walls and upper and lower guiding surfaces. Furthermore, a width of the cavity 28 may be selected to correspond to a lateral dimension of the internal magnet 90, while still permitting smooth sliding movement of the internal magnet 90 within the internal guiding cavity 28. The length of the internal magnet 90 may also be greater than the width of the internal guiding cavity 28, which may prevent the internal magnet 90 from rotating fully about a vertical axis within the cavity 28, as will be described in additional detail herein. It should be understood that the dimensional relationship between the internal magnet 90 and the internal guiding cavity 28 may prevent unintended flipping or inversion of the internal magnet 90 during operation.

Referring again to FIGS. 1 and 2, the primary shaft 40 may extent through the body 20 along a central axis, which may pass through opposite pole regions of the body 20. In these embodiments, the central axis may define a primary rotational axis P of the orbital display system 10. As further illustrated in FIGS. 1 and 2, the first primary shaft end 42 and the second primary shaft end 44 may each be configured to interface with a plurality of bearing assemblies 50 located at opposite ends of the body 20. In these embodiments, the upper body portion 24 may include a bearing receiving bore 27 at a first pole region, and the lower body portion 22 may include a bearing receiving bore 27 at a second pole region, and each bore may be configured to receive a corresponding bearing assembly.

In the embodiments described herein, the plurality of bearing assemblies 50 may permit relative rotation between the body 20 and the primary shaft 40 about the primary rotational axis P while maintaining axial alignment. Furthermore, the primary shaft 40 may be secured to the base 12, such that the body 20 may rotate relative to the primary shaft 40.

As further illustrated in FIGS. 1 and 2, the base 12 may include a receiving structure configured to accept the second primary shaft end 44 of the primary shaft 40. In this embodiment, the second primary shaft end 44 of the primary shaft 40 may include a non-circular geometry configured to mate with a complementary non-circular receiving structure formed in the base to prevent rotation of the primary shaft 40 relative to the base. It should be appreciated that this arrangement may fix the primary shaft 40 in rotational alignment relative to the base 12 while allowing the body 20 to rotate about the primary shaft 40 via the plurality of bearing assemblies 50.

Referring still to FIGS. 1 and 2, the orbiting object 100 may further include an embedded magnet 110 positioned within a recess 112 formed in the orbiting object 100. The embedded magnet 110 may be configured to magnetically couple with the internal magnet 90 positioned within the internal guiding cavity 28 once the body 20 is assembled. It should be appreciated that the magnetic coupling between the orbiting object 100 and the internal magnet 90 may enable transfer of both positional and orientational movement from the internal magnet 90 to the orbiting object 100 without a rigid mechanical linkage penetrating the body 20 (e.g., being positioned external to the body 20).

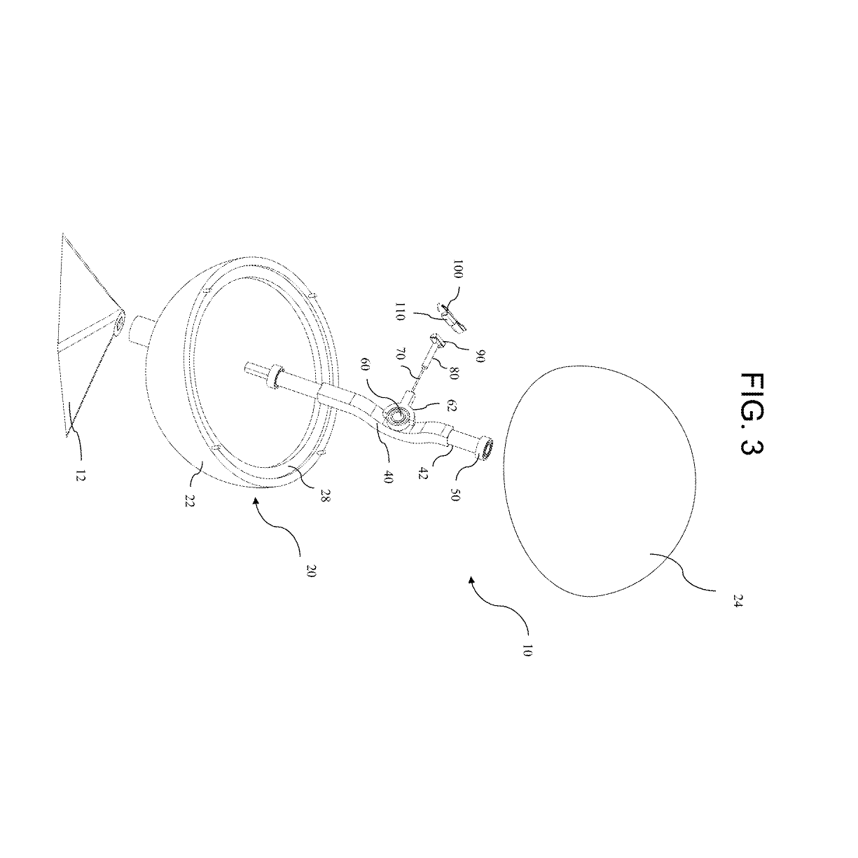

Turning now to FIG. 3, the orbital display system 10 may further include an internal multi-axis mechanism assembled on the primary shaft 40, with the internal multi-axis mechanism being assembled on the primary shaft 40 prior to enclosure within the body 20. It should be appreciated that, in these embodiments, the internal multi-axis mechanism may be configured to couple the internal magnet 90 to the primary shaft 40, with the internal magnet 90 being coupled to secure the orbiting object 100 to the body 20, as described hereinabove.

In the embodiment depicted in FIG. 3, the orbiting display system 10 may further include a central bearing assembly 60, which may be mounted on a segment of the primary shaft 40 oriented perpendicular to the primary rotational axis P. In these embodiments, the central bearing assembly 60 may define a secondary rotational axis that may be orthogonal to the primary rotational axis P. It should be appreciated that the secondary axis S may enable angular displacement of components attached to the central bearing assembly 60 in a north-south direction (e.g., in a +/- y-direction) relative to the body 20, as will be described in additional detail herein.

As further depicted in FIG. 3, the central bearing assembly 60 may be secured to a bearing attachment structure 62. The bearing attachment structure 62 may be rigidly coupled to the central bearing assembly 60 such that rotation about the secondary axis S results in corresponding angular displacement of the attachment structure. As depicted in FIG. 3, the bearing attachment structure 62 may be a y-shaped attachment member, a forked bracket, a clevis-type attachment structure, or any other similar structure including a central hub portion and a plurality of arms extending therefrom. It should be appreciated that, in these embodiments, the plurality of arms may define a receiving region which engages the central bearing assembly 60 and enables rotation about the secondary axis S while also preventing torsional twisting under cavity forces.

In the embodiments described herein, the orbital display system 10 may further include the radial extending member 70, with the proximal extending member end 74 of the radial extending member 70 being secured to the bearing attachment structure 62 and projecting outwardly from primary shaft 40 of the body 20. The radial extending member 70 may have a fixed length, such that the distal extending member end 72 maintains a substantially constant radial distance from the center of the body 20. Because the central bearing assembly 60 may be positioned at the center of the body 20, the distal end of the radial extending member 70 may trace a spherical surface concentric with the interior surface of the body 20, as will be described in additional detail herein.

Referring still to FIG. 3, the distal extending member end 72 of the radial extending member 70 may be received within a swivel assembly 80. The swivel assembly 80 may provide a third rotational degree of freedom about an axis substantially aligned with the longitudinal axis of the radial extending member 70. In these embodiments, the third axis may permit rotational adjustment of the internal magnet 90 relative to the radial extending member 70.

As further illustrated in FIG. 3, the internal magnet 90 may be secured to the swivel assembly 80 such that the internal magnet 90 translates with the radial extending member 70 while retaining the ability to rotate about the third axis. It should be appreciated that this configuration may allow the internal magnet 90 to adjust its heading orientation independently of its radial position relative to the center of the body 20. As provided herein, the term “heading” may refer to the angular orientation of the orbiting object relative to a direction of travel of the orbiting object along a surface of the body 20, as will be described in additional detail herein.

In combination, the primary shaft 40 and plurality of bearing assemblies 50 may define rotation about the primary axis, the central bearing assembly 60 may define rotation about the secondary axis, and the swivel assembly 80 may define rotation about the third axis. Accordingly, the three rotational degrees of freedom described herein may allow the internal magnet 90 to achieve controlled orientation in three-dimensional space while maintaining a constant radial distance from the center of the body 20, as described hereinabove.

In operation (e.g., when the body 20 is assembled) the internal magnet 90 may reside within the internal guiding cavity 28 described hereinabove with reference to FIGS. 1 and 2. Accordingly, as the body 20 rotates relative to the primary shaft 40 about the primary axis P, the internal guiding cavity 28 may impose positional displacement on the internal magnet 90. Because the internal magnet 90 is constrained to maintain a fixed radial distance from the center of the body 20 by the radial extending member 70, and because the internal magnet 90 may be free to rotate about the third axis via the swivel assembly 80, interaction with the internal guiding cavity 28 may produce coordinated north-south displacement and automatic heading adjustment of the orbiting object 100. As provided herein, the term “automatic heading adjustment” may refer to rotation of the internal magnet 90 about the secondary axis S of the radial extending member 70 in response to contact with the internal guiding cavity 28, such that the internal magnet 90 continuously aligns with a tangent of the internal guiding cavity path during operation of the orbital display system 10.

In the embodiments described herein, it should be further appreciated that the radial extending member 70 may function as a rigid radial linkage configured to transfer cavity-imposed displacement forces to the central bearing assembly 60 assembly, thereby causing angular displacement about the secondary axis S. Simultaneously, the swivel assembly 80 may permit the internal magnet 90 to align tangentially with the contour of the cavity path in order to prevent binding and ensure smooth motion of the orbiting object 100.

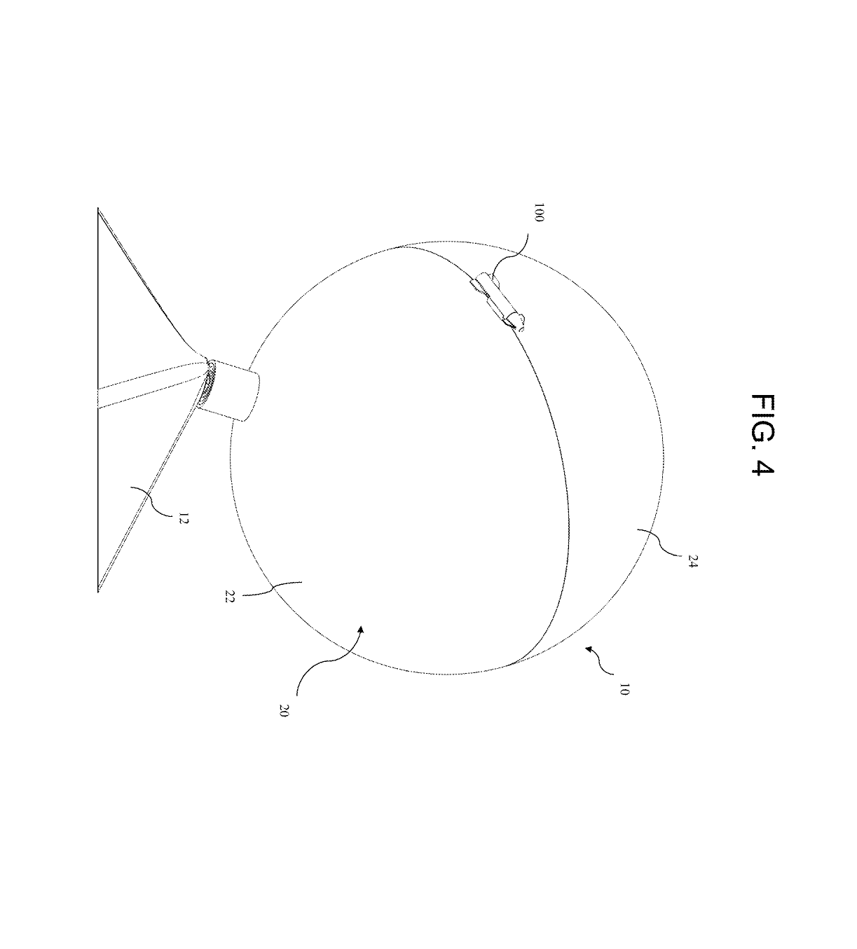

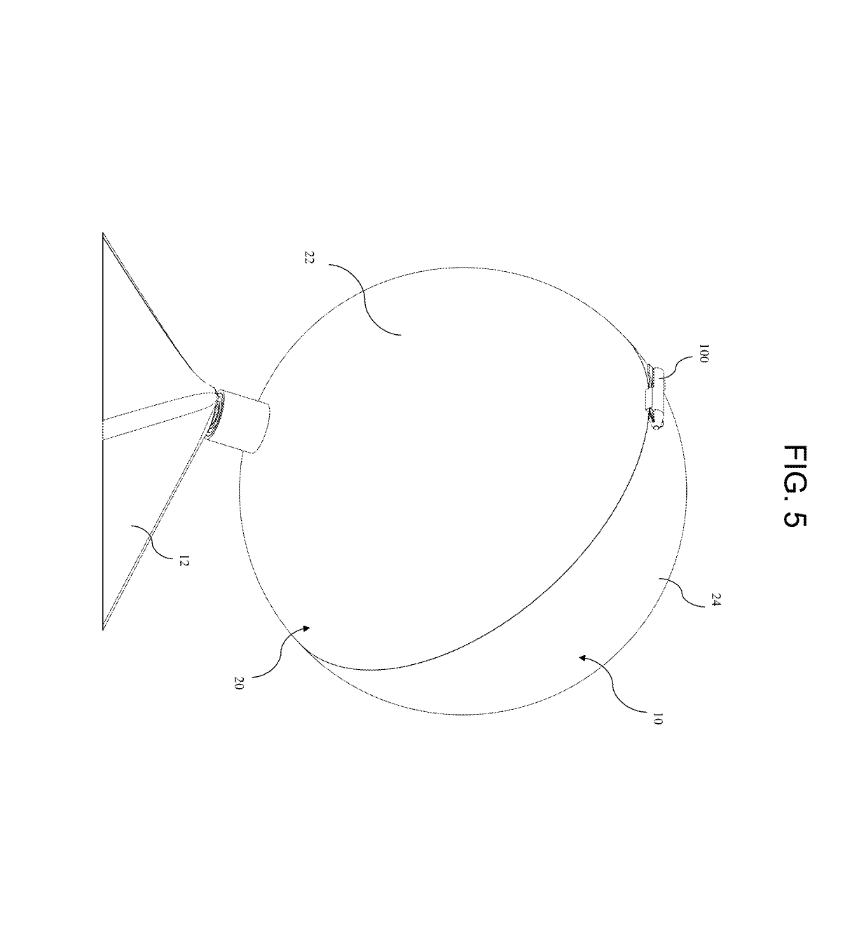

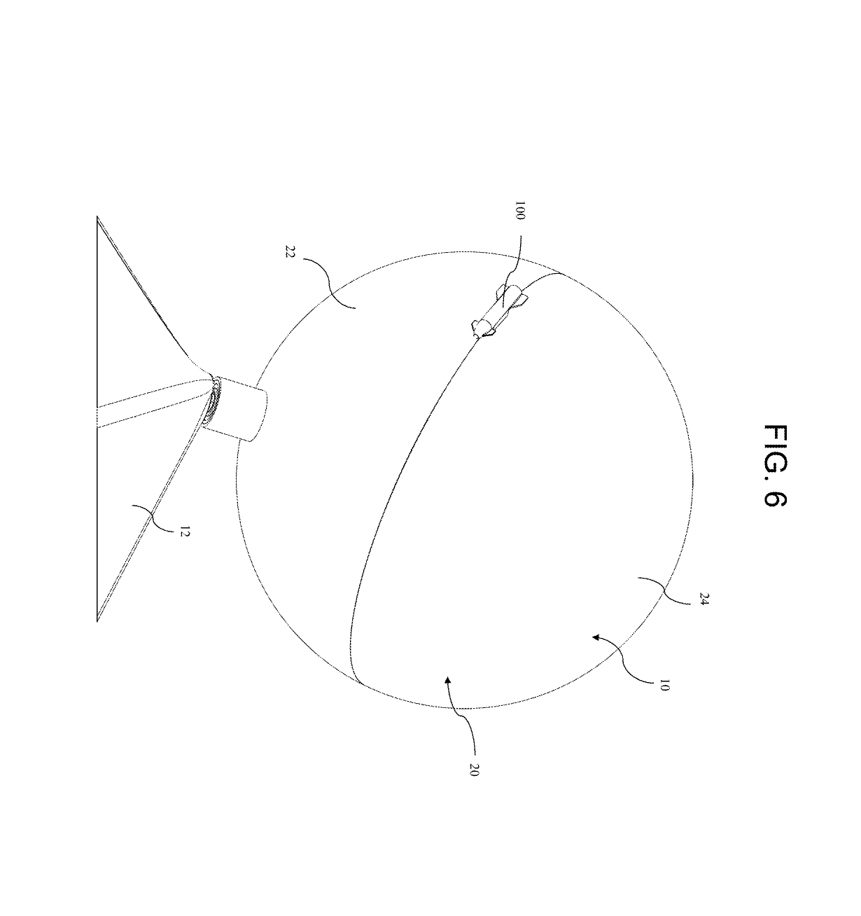

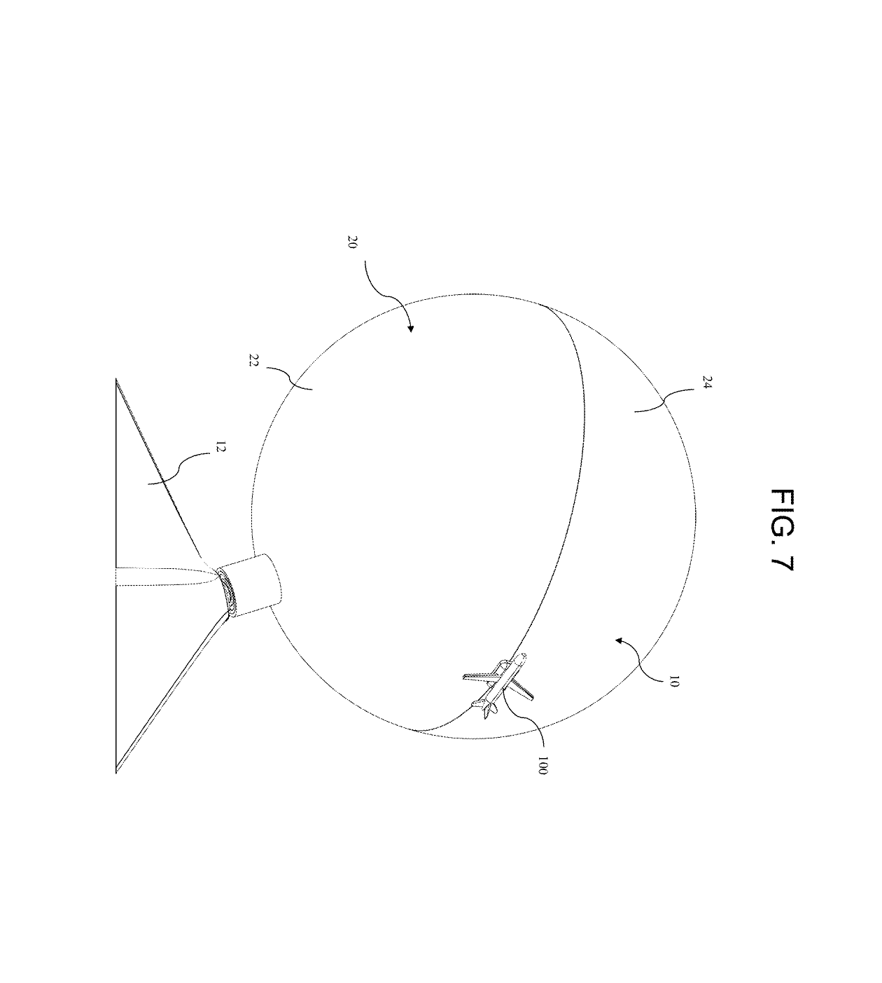

Turning now to FIGS. 4–7 operation of the orbital display system 10 is depicted in additional detail. For example, in these embodiments, when the upper and lower body portions 22, 24 are joined, the internal mechanism (e.g., central bearing assembly 60, radial extending member 70, etc.) described hereinabove with reference to FIG. 3 may be enclosed within the body 20, and the internal magnet 90 may within the internal guiding cavity 28. The primary shaft 40 may extend through the body 20 along the primary rotational axis P and may be secured relative to the base 12. As a result, the primary shaft 40 may remain rotationally fixed while the body 20 freely rotates about the primary rotation axis P.

As described hereinabove, it should be appreciated that the configuration of the orbital display system 10 described herein may establish relative motion between the body 20 and the various internal components. For example, because the primary shaft 40 and central bearing assembly 60 assembly are fixed relative to the base 12, any rotation of the body 20 may cause the internal guiding cavity 28 to move circumferentially about the internal magnet 90.

Furthermore, in some embodiments, the internal magnet 90 may not be stationary relative to the internal guiding cavity 28 because the internal magnet 90 may be confined within the internal guiding cavity 28. As the body 20 rotates, the sidewalls of the internal guiding cavity may translate relative to the internal magnet 90 and impose contact forces, which may be transmitted from the internal magnet 90 to the radial extending member 70 and then to the central bearing assembly 60 assembly.

Referring still to FIGS. 4 – 7, because the radial extending member 70 has a fixed length and may be pivotally mounted at the geometric center of the body 20 via the central bearing assembly 60, the radial extending member 70 may not translate radially. Instead, displacement forces may be resolved into angular rotation about the secondary rotational axis S. As described herein, this configuration may produce north-south angular displacement of the radial extending member 70 relative to the body 20. Accordingly, rotation of the body 20 about the primary axis P may be mechanically converted into angular displacement about the secondary axis S through interaction between the internal guiding cavity 28 and the internal magnet 90.

As further depicted in FIGS. 4 – 7, the geometry of the internal guiding cavity 28 may also impose orientation changes on the internal magnet 90. As a path of the internal guiding cavity 28 curves relative to the center of the body 20, the angular relationship between the internal guiding cavity 28 and the radial extending member 70 may change. In response, the swivel assembly 80 at the distal extending member end 72 of the radial extending member 70 may allow the internal magnet 90 to rotate about the heading axis. Contact between the internal magnet 90 and the internal guiding cavity 28 may induce rotation until the internal magnet 90 aligns tangentially with a local direction of the internal guiding cavity path, as has been described hereinabove. Accordingly, it should be appreciated that the swivel assembly 80 may prevent torsional resistance from building in the radial extending member 70 while allowing continuous automatic heading correction.

Referring still to FIGS. 4 – 7, in operation, the orbiting object 100 may be magnetically coupled to the internal magnet 90 through an exterior of the body 20. For example, in these embodiments, the embedded magnet 110 within the orbiting object 100 may align with the magnetic axis of the internal magnet 90 due to magnetic attraction. Because magnetic coupling transfers both translational force and rotational orientation, the orbiting object 100 may mirror the motion of the internal magnet 90.

It should be further appreciated that, in the embodiments described herein, relative circumferential movement may arise from rotation of the body 20 itself. That is, the internal magnet 90 may remain fixed relative to the primary shaft 40 in the circumferential direction, but because the internal guiding cavity 28 may be moving relative to the internal magnet 90, the internal magnet 90 may be forced to shift north or south and to rotate about the heading axis. Accordingly, during operation of the orbital display system 10, from the perspective of an observer viewing the exterior of the body 20, the orbiting object 100 may appear to move in both east-west (e.g., +/- x-direction) and north-south (e.g., +/- y-direction) along the surface of the body 20.

Referring still to FIGS. 4 – 7, it should be understood that the orbiting object 100 may be detached and replaced with a different orbiting object 100 containing a similarly positioned embedded magnet 110. Because the internal magnet 90 governs both position and orientation, any replacement orbiting object 100 may automatically follow the same path and heading behavior without alteration to the underlying components of the orbital display system 10.

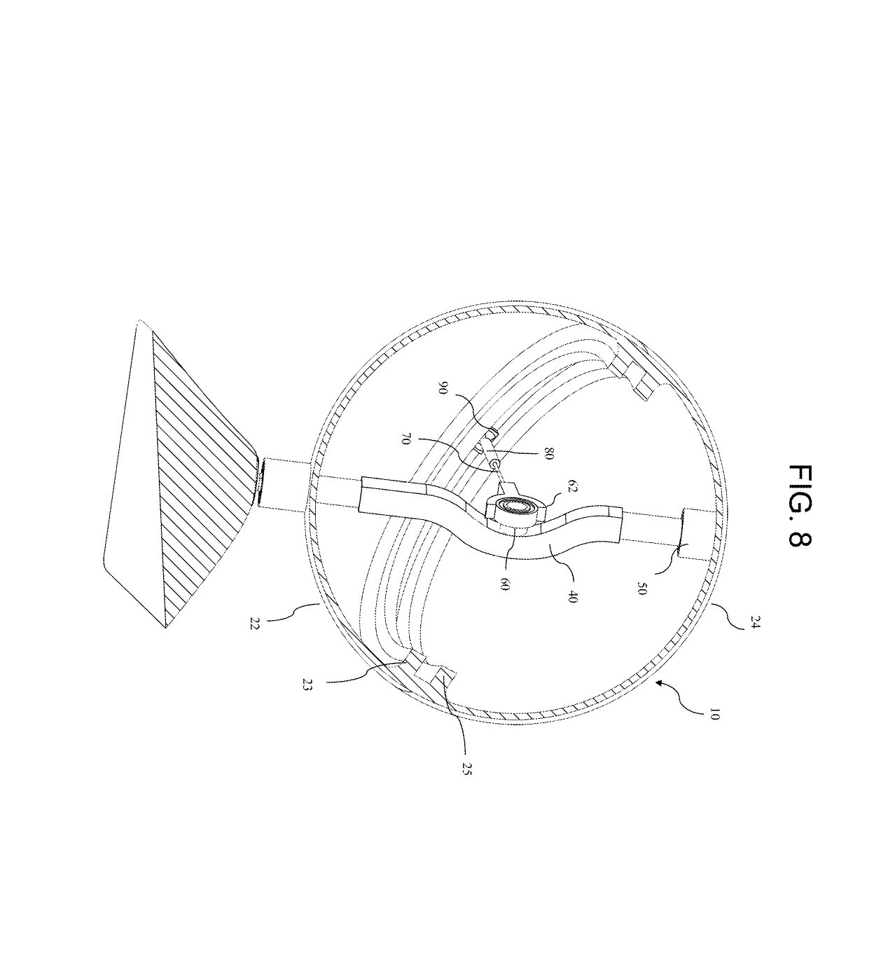

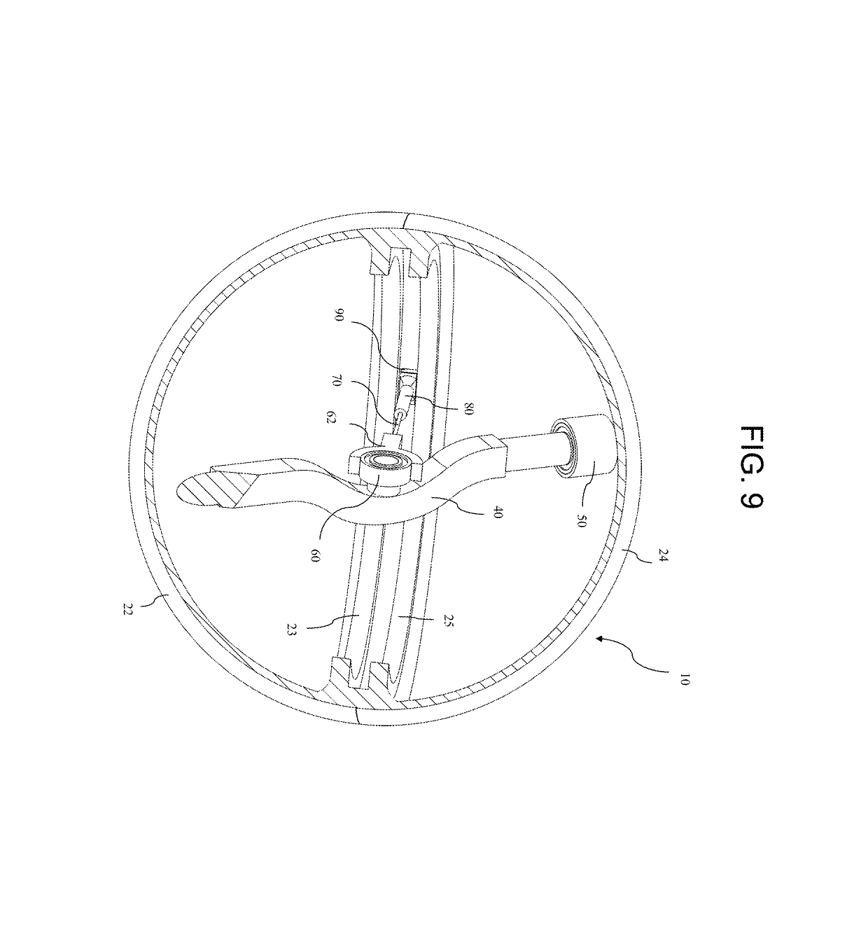

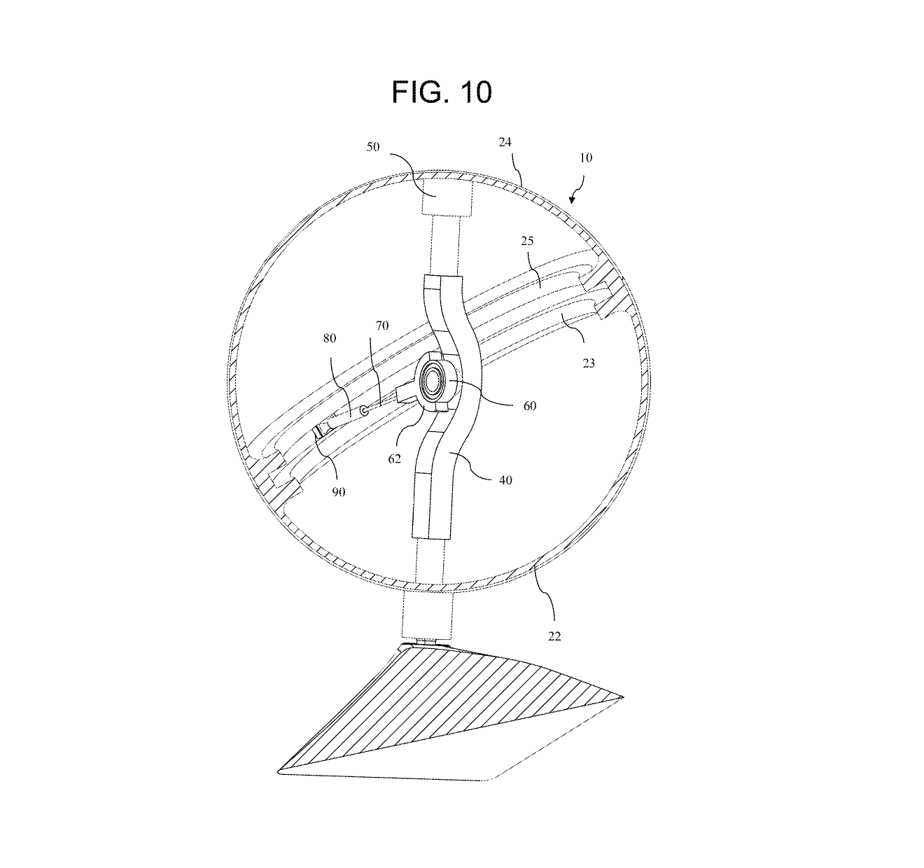

Referring now to FIGS. 8–10, an internal structural cooperation between the internal guiding cavity 28, the internal magnet 90, the radial extending member 70, the central bearing assembly 60 assembly, and the primary shaft 40 is depicted in additional detail.

In these embodiments, and described hereinabove, the longitudinal length of the internal magnet 90 may exceed the lateral width of the internal guiding cavity 28. This dimensional relationship may prevent the internal magnet 90 from rotating 180 degrees within the internal guiding cavity 28. Because the internal magnet 90 may be longer than the width of the internal guiding cavity 28, any attempt to rotate the internal magnet 90 about a vertical axis may cause interference with the sidewalls of the internal guiding cavity 28. Accordingly, this geometric constraint may prevent inversion of the internal magnet 90 and ensure that the magnetic orientation of the internal magnet 90 may remain consistent throughout operation.

Furthermore, due to the configuration of the internal guiding cavity 28 and the internal magnet 90 described herein, when the internal guiding cavity 28 shifts upward relative to the internal magnet 90, the sidewalls of the internal guiding cavity 28 may push against the internal magnet 90, thereby forcing the radial extending member 70 to rotate about the secondary axis S in a northward direction (e.g., in the + y-direction). Conversely, when the internal guiding cavity 28 shifts downward, the radial extending member 70 may rotate southward (e.g., in the – y-direction). As described hereinabove, this angular displacement may occur about the central bearing assembly 60, which may provide low-friction rotation about the secondary axis S while remaining rigidly fixed relative to the primary shaft 40.

Simultaneously, as the curvature of the internal guiding cavity 28 changes along its length, the orientation of the cavity 28 walls relative to the radial extending member 70 changes. Accordingly, the swivel assembly 80 may allow the internal magnet 90 to rotate about the radial extending member 70 axis in response to these changes in cavity 28 wall orientation.

In view of the foregoing, it should be appreciated that the geometry of the internal guiding cavity may allow for angular displacement of the radial extending member 70 about the secondary rotational axis, and rotational adjustment of the internal magnet 90 about the heading axis via the swivel assembly 80. These two motions may occur simultaneously and continuously as the body 20 rotates about the primary rotation axis P. That is, the internal magnet 90 may not independently rotate about the primary axis. Instead, relative motion between the rotating body 20 and the fixed primary shaft 40 may cause the internal guiding cavity 28 to translate around the internal magnet 90, thereby forcing the internal magnet 90 to move along the defined path.

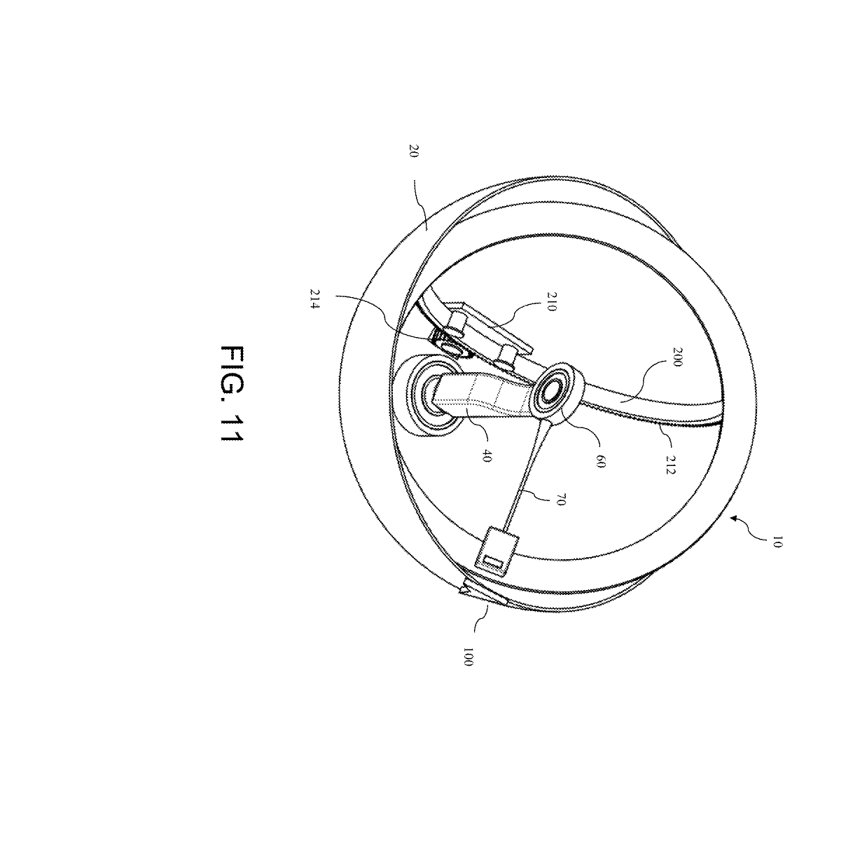

Referring now to FIGS. 11 - 14, another embodiment of an orbital display system 10 is depicted. It should be appreciated that the orbital display system of FIGS. 11-14 may be structurally similar to the orbital display system 10 of FIGS. 1-10, such that like reference numerals may be used to refer to like structure where appropriate.

As depicted in FIG. 11, in this embodiment, the orbital display system 10 may include a guide rail 200 that is configured to be angularly adjustable, such that the guide rail 200 is not fixed at a permanent angular orientation relative to the primary rotational axis P. For example, rather than being integrally formed within the mating surfaces of the upper and lower body portion 22, 24 at a fixed angle, the guide rail 200 may be formed as a discrete structural component supported within the body 20 and mounted in a manner that permits angular repositioning relative to the primary rotational axis P.

In these embodiments, the guide rail 200 may define a three-dimensional path and be configured to receive the internal magnet 90 and translate the internal magnet 90 along the defined three-dimensional path. Furthermore, the plane of the three-dimensional path defined by the guide rail 200 may be tilted relative to an equatorial plane of the body 20. For example, in order to tilt the guide rail 200, the orbital display system 10 may further include a plurality of internal support members that may be mechanically coupled to an adjustment mechanism 210.

As further illustrated in FIG. 11, the adjustment mechanism 210 may permit controlled variation of the angular orientation of the guide rail 200 about an axis that intersects or may be parallel to the primary rotational axis P. In some embodiments, the guide rail 200 may be mounted on pivot points positioned near opposing ends of the rail structure. In these embodiments, a rotational adjustment member, cam structure, threaded adjustment member, or similar positioning mechanism may be coupled to the guide rail 200 to allow selective angular displacement of the guide rail 200, as will be described in additional detail herein. By altering the angular orientation of the guide rail 200 relative to the primary rotation axis P, the amplitude of north–south displacement imposed on the internal magnet 90 during rotation of the body 20 may be modified.

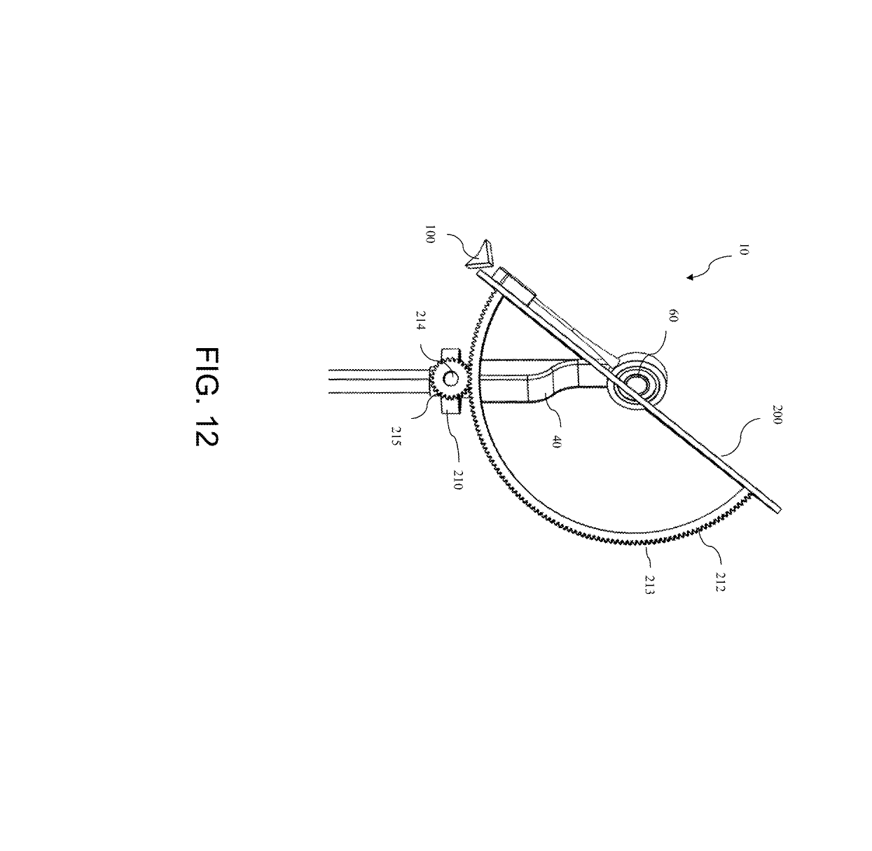

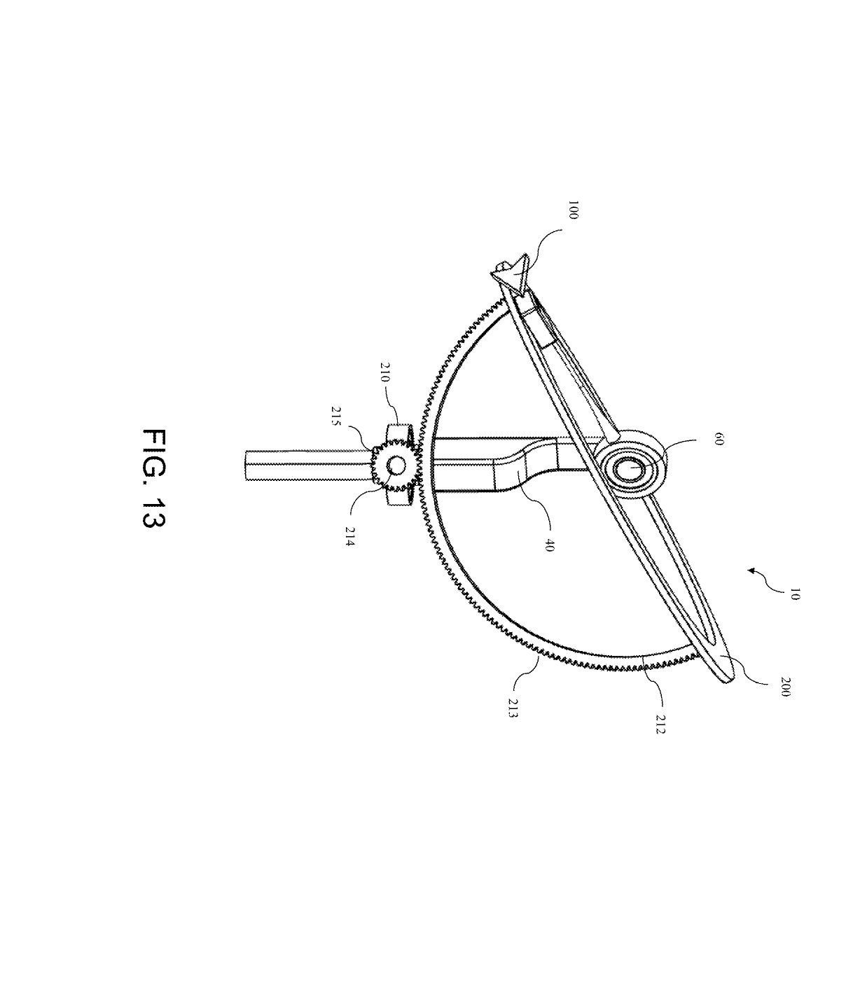

Turning now to FIGS. 12 and 13, the adjustment mechanism 210 is depicted in additional detail. For example, in these embodiments, the adjustment mechanism 210 may include a toothed rail segment 212 and a gear member 214, such that mechanical interaction between the toothed rail segment 212 and the gear member 214 permit controlled angular repositioning of the guide rail 200 relative to the primary rotational axis P.

In these embodiments, the toothed rail segment 212 may be formed along a structural portion of the guide rail 200 or along a rail support bracket rigidly connected to the guide rail 200. The toothed rail segment 212 may include a plurality of teeth 213, which may be regularly (e.g., evenly, consistently, etc.) spaced arranged along an arcuate profile centered along the rail adjustment axis. It should be appreciated that, in these embodiments, the plurality of teeth 213 may be involute gear teeth, ratchet-style teeth, or similarly profiled engagement features capable of transmitting torque without departing from the scope of the present disclosure.

As further depicted in FIGS. 12 and 13, the gear member 214 may be mounted adjacent the toothed rail segment 212. The gear member 214 may be supported for rotation about a gear axis fixed relative to the body 20, and may include a plurality of complementary gear teeth 215 configured to mesh with the plurality of teeth 213 of the toothed rail segment 212 of the guide rail 200. It should be appreciated that the gear axis may be positioned such that rotational movement of the gear member 214 causes the plurality of gear teeth 215 to engage and drive the toothed rail segment 212 of the guide rail 200.

In operation, when the gear member 214 is rotated (e.g., either manually via an external adjustment knob or mechanically via a motorized actuator), the plurality of gear teeth 215 may advance along the toothed rail segment 212 of the guide rail 200. Because the toothed rail segment 212 may be rigidly fixed to the guide rail 200, engagement between the gear member 214 and the toothed rail segment 212 may apply torque to the guide rail 200 about the rail adjustment axis. In these embodiments, as torque is applied, the guide rail 200 may pivot about the rail adjustment axis.

For example, FIGS. 12 and 13 depict the guide rail 200 translating between a low-profile orientation (e.g., FIG. 12) toward a medium-profile orientation (e.g., FIG. 13). In the low-profile configuration, the path of the guide rail 200 may be oriented closer to a plane perpendicular to the primary axis P. As the guide rail 200 is rotated via actuation of the gear member 214, the guide rail 200 may be tilted such that its curvature may include a greater vertical gradient relative to the primary axis P. This rotation may increase the north–south component of displacement forces transmitted to the internal magnet 90 during body 20 rotation.

Throughout the adjustment process described herein, the engagement of the toothed rail segment 212 and the gear member 214 may prevent unintended movement of the guide rail 200 due to operational forces generated by contact with the internal magnet 90. For example, reaction forces may be transmitted into the guide rail 200, through the toothed rail segment 212, and into the gear member 214. Furthermore, because the gear member 214 may be supported by the body 20, these reaction forces may be ultimately resolved into the structure of the body 20. Once the desired angular orientation of the guide rail 200 is reached, the plurality of gear teeth 215 may remain engaged with the toothed rail segment 212, thereby locking the guide rail 200 at the selected position.

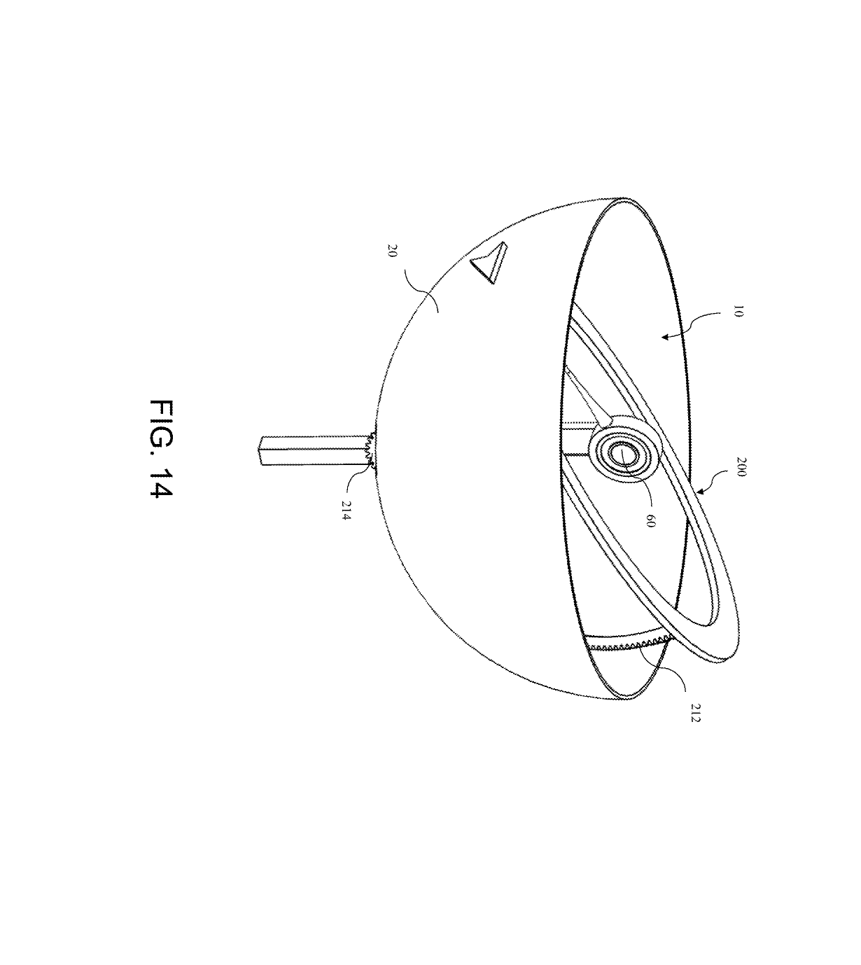

Turning now to FIG. 14, the adjustment mechanism 210 is depicted in connection with a lower body portion 22 of the body 20. For example, as illustrated in FIG. 14, the gear member 214 may at least partially extend from a portion of the body 20 (e.g., the lower body portion 22 or upper body portion 24) that permits repositioning of the guide rail 200 without disassembly of the body 20.

In this embodiment, the gear member 214 that engages the toothed rail segment 212 of the guide rail may be mounted on a gear shaft supported by the body 20 or by an internal support structure fixed relative to the body 20. The lower portion of the gear member 214 may extend downward from the interior of the body 20 and pass through an opening formed in the lower body portion 22. The opening may be sized to permit rotational clearance of the gear member 214 while maintaining structural integrity of the body 20. The gear member 214 may extend through a bushing, bearing sleeve, or reinforced aperture to reduce wear and maintain alignment.

In operation, a user-engagement portion may be provided at the lower end of the gear member 214, such as a knurled knob, ridged wheel, recessed slot, hex drive interface, or other manually operable structure configured to allow a user to apply torque to the gear member 214. When a user rotates the exposed lower portion of the gear member 214, torque may be transmitted directly to the toothed rail segment 212 positioned within the body 20. Because the gear member 214 may be mechanically coupled to the guide rail 200 through positive tooth engagement, rotation of the externally accessible portion of the gear member 214 may produce angular displacement of the guide rail 200 without requiring separation of the lower body portion 22 and upper body portion 24.

In view of the foregoing, it should be appreciated that the embodiments described herein relate to an orbital display system that implements an internal mechanism that includes a plurality of orthogonal rotation axes, an extending member, a cavity-guided magnet assembly, and a magnetically coupled orbiting object that produces smooth, predictable, and aesthetically pleasing orbital motion through coordinated body rotation and cavity-imposed guidance without use of exposed linkages. While exemplary embodiments are described above, it is not intended that these embodiments describe all possible forms encompassed by the claims. The words used in the specification are words of description rather than limitation, and it is understood that various changes can be made without departing from the spirit and scope of the disclosure.

The foregoing descriptions are only embodiments of the present disclosure and are not intended to limit the present disclosure. As previously described, the features of various embodiments can be combined to form further embodiments of the invention that may not be explicitly described or illustrated. While various embodiments could have been described as providing advantages or being preferred over other embodiments with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments with respect to one or more characteristics, these embodiments are not outside the scope of the disclosure and can be desirable for particular applications.

Furthermore, it should be apparent that the present disclosure is not limited to the details of the above-mentioned exemplary embodiments, and the present disclosure can be implemented in other specific forms without departing from the spirit or basic features of the present disclosure. Therefore, no matter from which point of view, the embodiments should all be regarded as exemplary and non-limiting. The scope of the present disclosure is defined by the appended claims rather than the above-mentioned description, and therefore it is intended that all changes which fall within the meaning and range of equivalents of the claims are embraced in the present disclosure. Any reference signs in the claims should not be construed as limiting the claims involved. In addition, it is apparent that the word "comprise/include" does not exclude other elements or steps, and the singular does not exclude the plural. The terms first, second, etc. are used for designations and do not represent any particular order.

It should be understood that the embodiments as shown in the drawings only show the optional shapes, sizes and arrangements of optional components of the dynamic orbital display according to the present disclosure, which are merely illustrative but not restrictive, and other shapes, sizes and arrangements may be employed without departing from the idea and scope of the present disclosure.

The technical contents and technical features of the present disclosure are disclosed above, but it can be understood that those skilled in the art would have made various variations and improvements to the concepts disclosed above under the creative idea of the present disclosure, and all the variations and improvements fall into the scope of protection of the present disclosure. The descriptions of the above embodiments are illustrative but not restrictive, and the scope of protection of the present disclosure is determined by the claims.

What is claimed is:

1. An orbital display system comprising:
a body;
a primary shaft extending through the body along a primary rotational axis;
at least one bearing assembly permitting relative rotation between the body and the primary shaft about the primary rotational axis;
a central bearing assembly supported by the primary shaft and defining a secondary rotational axis that is non-parallel to the primary rotational axis;
an extending member coupled to the central bearing assembly and extending radially outward from the secondary rotational axis;
an internal magnet positioned at a distal extending member end of the extending member;
an internal guiding cavity configured to receive and constrain movement of the internal magnet; and
an orbiting object positioned externally relative to the body and magnetically coupled to the internal magnet;
wherein rotation of the body about the primary rotational axis causes displacement of the extending member about the secondary rotational axis and corresponding movement of the orbiting object relative to the body.

2. The orbital display system of claim 1, wherein the secondary rotational axis is perpendicular to the primary rotational axis.

3. The orbital display system of claim 1, further comprising a swivel assembly positioned between the extending member and the internal magnet, the swivel assembly permitting rotation of the internal magnet about an axis aligned with the extending member.

4. The orbital display system of claim 3, wherein the swivel assembly permits continuous tangential alignment of the internal magnet relative to the internal guiding cavity.

5. The orbital display system of claim 1, wherein the extending member has a fixed length, such that the internal magnet maintains a constant radial distance from a center of the body.

6. The orbital display system of claim 1, wherein the body further includes an upper body portion and a lower body portion releasably coupled to the upper body portion.

7. The orbital display system of claim 1, wherein the orbiting object further includes an embedded magnet configured to align with the internal magnet.

8. The orbital display system of claim 1, wherein rotation of the primary shaft about the primary rotational axis causes displacement of the extending member about the secondary rotational axis and corresponding movement of the orbiting object relative to the body.

9. An orbital display system comprising:
a body including a lower body portion and an upper body portion releasably coupled to the lower body portion;
a primary shaft extending through the body along a primary rotational axis;
a central bearing assembly positioned at a center of the body;
an extending member having a fixed length and coupled to the central bearing assembly;
an internal guiding cavity formed within the body and defined at least in part by the lower body portion and the upper body portion;
an internal magnet positioned within the internal guiding cavity and coupled to a distal extending member end of the extending member; and
an orbiting object magnetically coupled to the internal magnet, such that the orbiting object is external to the body;
wherein rotation of the primary shaft about the primary rotational axis causes displacement of the extending member about the secondary rotational axis and corresponding movement of the orbiting object relative to the body.

10. The orbital display system of claim 9, wherein the internal guiding cavity is fully enclosed when the lower body portion is releasably coupled to the upper body portion.

11. The orbital display system of claim 9, wherein the cavity includes a pair of opposing sidewalls spaced apart by a distance that is greater than a width of the internal magnet.

12. The orbital display system of claim 11, wherein a length of the internal magnet exceeds a space defined by the internal guiding cavity to prevent inversion of the internal magnet within the internal guiding cavity.

13. The orbital display system of claim 9, further comprising a plurality of alignment members configured to align the lower body portion and the upper body portion.

14. The orbital display system of claim 9, wherein the primary shaft is rotationally fixed relative to a supporting base.

15. An orbital display system comprising:
a body;
a primary shaft defining a primary rotational axis;
a central bearing assembly defining a secondary rotational axis;
an extending member coupled to the central bearing assembly;
an internal magnet coupled to the extending member;
a guiding rail configured to constrain movement of the internal magnet; and
an adjustment mechanism configured to vary an angular orientation of the guiding rail relative to the primary rotational axis;
wherein varying the angular orientation of the guiding rail modifies a displacement path imposed on the internal magnet during rotation about the primary rotational axis.

16. The orbital display system of claim 15, wherein the adjustment mechanism comprises a toothed rail segment coupled to the guiding rail and a gear member configured to engage the toothed rail segment.

17. The orbital display system of claim 16, wherein rotation of the gear member produces angular displacement of the guiding rail about a rail adjustment axis.

18. The orbital display system of claim 16, wherein the gear member includes a portion that protrudes through the body to permit manual rotation by a user.

19. The orbital display system of claim 15, wherein varying the angular orientation of the guiding rail alters a displacement amplitude of an orbiting object magnetically coupled to the internal magnet during rotation about the primary rotational axis.

20. The orbital display system of claim 15, further comprising a swivel assembly positioned between the extending member and the internal magnet, the swivel assembly permitting rotation of the internal magnet about an axis aligned with the extending member.
